(19) United States
(12) Patent Application Publication
(10) Pub. No.: US 2005/0038205 A1
(43) Pub. Date: Feb. 17, 2005

(54) Thermally curable powder coating compositions and their use

(75) Inventors: Andreas Wenning, Nottuln (DE); Friedrich Georg Schmidt, Haltern am See (DE); Adolf Kuhnle, Marl (DE); Carsten Jost, Marl (DE); Marielle Wouters, Heeze (NL); Henk Van Bracht, Eindhoven (NL)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/886,621

(22) Filed: Jul. 9, 2004

(30) Foreign Application Priority Data
Jul. 11, 2003 (DE) 103 31 796.1

(51) Int. Cl. C08L 83/00

(52) U.S. Cl. 525/474; 524/858

(57) ABSTRACT

A heat-curable powder coating composition is provided that can form crosslinked films exhibiting enhanced hydrophobicity. The coating composition comprises a compound having functionalized polyhedral oligomeric silicon-oxygen cluster units.

### BACKGROUND OF THE INVENTION

1. Field of the Invention

The present invention relates to powder coating compositions. In particular, the present invention relates to heat-curable powder coating compositions whose crosslinked films exhibit an enhanced hydrophobicity.

2. Discussion of the Background

Thermally curable powder coating materials are increasingly being used to coat a very wide variety of substrates. One of the many reasons for this, besides their outstanding film properties, is the environmental compatibility of these products, particularly as compared with solvent-borne coating materials. In comparison with thermoplastic pulverulent compositions, thermosetting powder coating materials are generally harder and more resistant to solvents and detergents, possess better adhesion to metallic substrates, and do not soften on exposure to elevated temperatures.

Heat-curable powder coating materials are described in numerous patents, examples including EP 0 536 085, EP 0536085, U.S. Pat. No. 4,076,917, EP 0 322 834, WO 0075212, WO 0157148, WO 0050384, WO 0055266, EP 0600546, EP 0742805, EP 0698053, U.S. Pat. No. 6,069,221, DE 27 35 497, DE 30 30 572, DE 44 06 444, EP 0565924, U.S. Pat. No. 4,939,213, EP 0624577, U.S. Pat. No. 5,084,541, DE 2324696, DE 3026455, DE 3026456 and DE 23 24 696.

A feature common to all heat-curable powder coating materials is the very good leveling, adhesion, and elasticity of their films. However, the films do not possess a pronounced hydrophobic surface. As a result, water and/or dirt, for instance, are not sufficiently repelled from the films.

### SUMMARY OF THE INVENTION

The present invention provides heat-curable powder coating compositions whose films possess hydrophobic surface properties without detracting from very good mechanical film properties.

This has surprisingly been achieved by means of a heat-curable powder coating composition comprising a compound having functionalized polyhedral oligomeric silicon-oxygen cluster units.

### DETAILED DESCRIPTION OF PREFERRED EMBODIMENTS

The invention provides thermally curable powder coating compositions comprising
I. a binder comprising
   a) at least one compound having on average more than one functional group and
   b) at least one compound having on average more than one functional group complementary to a); and
II. at least one compound comprising polyhedral oligomeric silicon-oxygen cluster units, in accordance with the formula
   [(RₐX_{b}SiO_{1.5})ₘ (R_{c}X_{d}SiO)ₙ (RₑX_{f}Si₂O_{2.5})ₒ (R_{g}XₕSi₂O₂)ₚ]
   with a, b, c=0-1; d=1-2; e, f, g=0-3; h=1-4; m+n+o+p≧4; a+b=1; c+d=2; e+f=3 and g+h=4;

R=a hydrogen atom, alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units, attached via a polymer unit or a bridge unit,

X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group or substituents of type R containing at least one such group of type X,

the substituents of type R being identical or different and the substituents of type X being identical or different, and
III. auxiliaries and additives.

The invention likewise provides for the use of compositions comprising
I. a binder comprising
   a) at least one compound having on average moire than one functional group and
   b) at least one compound having on average more than one functional group complementary to a); and
II. at least one compound comprising polyhedral oligomeric silicon-oxygen cluster units, in accordance with the formula
   [(RₐX_{b}SiO_{1.5})ₘ (R_{c}X_{d}SiO)ₙ (RₑX_{f}Si₂O_{2.5})ₒ (R_{g}XₕSi₂O₂)ₚ]
   with a, b, c=0-1; d=1-2; e, f, g=0-3; h=1-4; m+n+o+p≧4; a+b=1; c+d=2; e+f=3 and g+h=4;

R=a hydrogen atom, alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units, attached via a polymer unit or a bridge unit,

X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group or substituents of type R containing at least one such group of type X,

the substituents of type R being identical or different and the substituents of type X being identical or different, and
III. auxiliaries and additives for preparing thermally curable powder coating compositions.

The invention further provides a process for preparing thermally curable powder coating compositions comprising
I. a binder comprising
   a) at least one compound having on average more than one functional group and
   b) at least one compound having on average more than one functional group complementary to a); and
II. at least one compound comprising polyhedral oligomeric silicon-oxygen cluster units, in accordance with the formula
   [(RₐX_{b}SiO_{1.5})ₘ (R_{c}X_{d}SiO)ₙ (RₑX_{f}Si₂O_{2.5})ₒ (R_{g}XₕSi₂O₂)ₚ]
   with a, b, c=0-1; d=1-2; e, f, g=0-3; h=1-4; m+n+o+p≧4; a+b=1; c+d=2; e+f=3 and g+h=4;

R=a hydrogen atom, alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units, attached via a polymer unit or a bridge unit,

X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group or substituents of type R containing at least one such group of type X,

the substituents of type R being identical or different and the substituents of type X being identical or different, and
III. auxiliaries and additives in heatable kneading apparatus, especially extruders, observing an upper temperature limit of 140° C., preferably of 130° C. and more preferably of 120° C.

The invention additionally provides a process for producing coatings by using thermally curable powder coating compositions comprising
I. a binder comprising
   a) at least one compound having on average more than one functional group and
   b) at least one compound having on average more than one functional group complementary to a); and
II. at least one compound comprising polyhedral oligomeric silicon-oxygen cluster units, in accordance with the formula
   [(RₐX_{b}SiO_{1.5})ₘ (R_{c}X_{d}SiO)ₙ (RₑX_{f}Si₂O_{2.5})ₒ (R_{g}XₕSi₂O₂)ₚ]
   with a, b, c=0-1; d=1-2; e, f, g=0-3; h=1-4; m+n+o+p≧4; a+b=1; c+d=2; e+f=3 and g+h=4;

R=a hydrogen atom, alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units, attached via polymer unit or a bridge unit,

X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group or substituents of type R containing at least one such group of type X,

the substituents of type R being identical or different and the substituents of type X being identical or different, and
III. auxiliaries and additives.

The binder I comprises at least one compound a) which is cured thermally by reaction with at least one compound b) to a powder coating material.

Component I a) can be a low molecular mass, oligomeric or polymeric compound containing on average more than one reactive functional group. The reactive functional groups present in component I a) can be identical to or different from one another.

Component I a) possesses a melting range betweenm 50 and 140° C. It may be amorphous or (semi)crystalline.

Component I a) comprises, for example, a representative from the class of the polyethers, polythioethers, polyacetals, polyesteramides, epoxy resins, amino resins, polyazomethines, polyurethanes, polysulfonamides, melamine derivatives, cellulose esters, cellulose ethers, polyvinyl esters, polyesters, and acrylate resins. The components may also be hyperbranched or dendrimeric.

Examples of suitable functional groups include C—C double bonds and OH—, SH—, COOH— or epoxy groups.

Any desired mixtures of these compounds are also possible.

Preferred components I a) are polyesters, polyacrylates or epoxy resins which carry hydroxyl, carboxyl and/or epoxy groups.

Component I b) may be a low molecular mass, oligomeric or polymeric compound containing on average more than one reactive functional group which reacts with the reactive groups of component I a) by means of heat. The reactive functional groups present in component I b) may be identical to or different from one another. Component I b) possesses a melting point between 50 and 140° C. It may be amorphous or (semi)crystalline.

Component I b) comprises, for example, epoxides, β-hydroxyalkylamides, carboxylic acids, carboxylic anhydrides, isocyanates, uretdiones, glycolurils, and tris(alkoxycarbonylamino)-1,3,5-triazines.

Any desired mixtures of these compounds are also possible.

Preferred components I b) are triglycidyl isocyanurate, aromatic glycidyl esters, epoxidized fatty acid esters, dicarboxylic acids such as dodecanedioic acid, polycarboxylic acids, carboxylic anhydrides, blocked isocyanate adducts, polyaddition compounds having uretdione groups, methoxymethylglycoluril, 2,4,6-tris(methoxycarbonylamino)-1,3,5-triazine, 2,4,6-tris-(butoxycarbonylamino)-1,3,5 -triazine, 2,4,6-tris(ethylhexoxycarbonylamino)-1,3,5 -triazine, 2-phenylimidazoline or salts of pyromellitic acid with 2-phenylimidazoline.

Component I is described in numerous patents, examples including EP 536 085, EP 536 085, U.S. Pat. No. 4,076,917, EP 322 834, WO 00/75212, WO 01/57148, WO 00/50384, WO 00/55266, EP 600 546, EP 742 805, EP 698 053, U.S. Pat. No. 6,069,221, DE 27 35 497, DE 30 30 572, DE 44 06 444, EP 565 924, U.S. Pat. No. 4,939,213, EP 624 577, U.S. Pat. No. 5,084,541, DE 23 24 696, DE 30 26 455, DE 30 26 456, and DE 23 24 696.

It comprises, for example, the combination of the following compounds:

Polyesters having carboxyl end groups with triglycidyl isocyanurate (e.g., Araldit® PT 810 from Vantico AG), polyesters having carboxyl end groups with a mixture of aromatic glycidyl esters (e.g., Araldit® PT 910 or Araldit® PT 912 from Vantico AG), polyesters having carboxyl end groups with a β-hydroxyalkyamide (e.g., VESTAGON® EP-HA 320 from Degussa AG, Primid® XL-552, Primid® QM 1260 or Primid® SF 4510 from EMS-Primid, Prosid® H or Prosid® S from SIR), polyesters having carboxyl end groups with an aliphatic oxirane (e.g., Uranox® P 7200, Uranox® P 7300, Uranox® P 7400 or Uranox® P 7455 from DSM Resins), glycidyl methacrylate resin with dodecanedioic acid, polyesterpolyol with a blocked isocyanate adduct (e.g., VESTAGON® B 1530, VESTAGON® B 1400 or VESTAGON® B 1065 from Degussa AG), polyesterpolyol with a polyaddition compound having uretdione groups (e.g., VESTAGON® BF 1540, VESTAGON® BF 1320 from Degussa AG), polyesterpolyol with methoxymethylglycoluril (e.g., Powderlink® 1174 from Cytec Industries), polyesterpolyol with 2,4,6-tris(methoxycarbonylamino)-1,3,5-triazine or 2,4,6-tris(butoxycarbonylamino)-1,3,5 -triazine (from Cytec Industries, for example), epoxy resin with 2,4,6-tris(methoxycarbonylamino)-1,3,5-triazine or 2,4,6-tris(butoxycarbonylamino)-1,3,5-triazine (from Cytec Industries, for example), epoxy resin with 2-phenylimidazoline (e.g., VESTAGON B 31 from Degussa AG), epoxy resin with a polyester having carboxyl end groups, epoxy resin and a polyester having carboxyl end groups with an organic salt (e.g., VESTAGON® B 55 or VESTAGON® B 68 from Degussa AG).

The binders can be mixed with one another as desired.

The compound II comprises polyhedral oligomeric silicon-oxygen cluster units, in accordance with the formula
[(RₐX_{b}SiO_{1.5})ₘ (R_{c}X_{d}SiO)ₙ (RₑX_{f}Si₂O_{2.5})ₒ (R_{g}XₕSi₂O₂)ₚ]
with a, b, c=0-1; d=1-2; e, f, g=0-3; h=1-4; m+n+o+p≧4; a+b=1; c+d=2; e+f=3 and g+h=4;

R=a hydrogen atom, alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units, attached via a polymer unit or a bridge unit,

X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group or substituents of type R containing at least one such group of type X,

the substituents of type R being identical or different and the substituents of type X being identical or different.

A polyhedral oligomeric silicon-oxygen cluster preferably connotes the two classes of compound of the silsesquioxanes and of the spherosilicates.

Silsesquioxanes are oligomeric or polymeric substances whose completely condensed representatives possess the general formula (SiO_{3/2}R)ₙ, where n≧4 and the radical R can be a hydrogen atom but is usually an organic radical. The smallest structure of a silsesquioxane is the tetrahedron. Voronkov and Lavrent'yev (Top. Curr. Chem. 102 (1982), 199-236) describe the synthesis of completely and of incompletely condensed oligomeric silsesquioxanes by hydrolytic condensation of trifunctional RSiY₃ precursors, where R is a hydrocarbon radical and Y is a hydrolyzable group, such as chloride, alkoxide or siloxide, for example. Lichtenhan et al. describe the base-catalyzed preparation of oligomeric silsesquioxanes (WO 01/10871). Silsesquioxanes of the formula R₈Si₈O₁₂ (with identical or different hydrocarbon radicals R) can be reacted with base catalysis to functionalized, incompletely condensed silsesquioxanes, such as R₇Si₇O₉(OH)₃ or else R₈Si₈O₁₁(OH)₂ and R₈Si₈O₁₀(OH)₄, for example (Chem. Commun. (1999), 2309-10; Polym. Mater. Sci. Eng. 82 (2000), 301-2; WO 01/10871), and hence may serve as a parent compound for a multiplicity of different incompletely condensed and functionalized silsesquioxanes. The silsesquioxanes (trisilanols) of the formula R₇Si₇O₉(OH)₃ in particular can be reacted with functionalized monomeric silanes (comer capping) and so converted into correspondingly modified oligomeric silsesquioxanes.

If the compound II comprising polyhedral oligomeric silicon-oxygen clusters is from the class of compounds of the silsesquioxanes, they possess the following formula:
[(RₐX_{b}SiO_{1.5})ₘ (R_{c}X_{d}SiO)ₙ]
with a, b, c=0-1; d=1-2; m+n≧4; a+b=1; c+d=2.

Preference is given to compounds which are functionalized and whose functionalized polyhedral oligomeric silicon-oxygen cluster unit is based essentially on structure 1 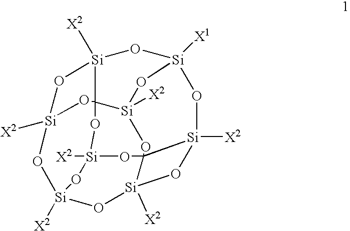
with X¹=substituent of type X or of type —O—SiX₃, and X²=substituent of type X, of type —O—SiX₃, of type R, of type —O—SiX₂R, of type —O—SiXR₂ or of type —O—SiR₃,

R=a hydrogen atom or alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units attached via a polymer unit or a bridge unit, and

X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group or substituents of type R containing at least one such group of type X.

Preference is also given to compounds based essentially on the functionalized oligomeric silsesquioxane unit of structure 2, 3 or 4 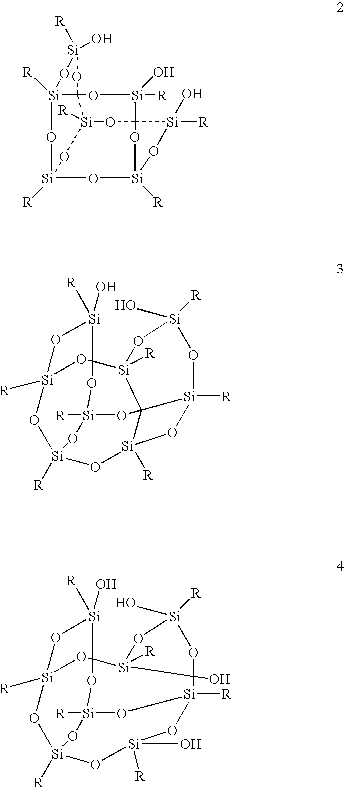
with R=a hydrogen atom or alkyl, cycloalkyl, alkenyl, cycloalkenyl, alkynyl, cycloalkynyl, aryl or heteroaryl group or polymer unit, each of which is substituted or unsubstituted, or further functionalized oligomeric silsesquioxane units attached via a polymer unit or a bridge unit, the silsesquioxane unit being functionalized via at least one hydroxyl group.

The substituents of type R of the silsesquioxane units can all be identical, producing what is called a functionalized homoleptic structure thus
[(RSiO_{1.5})ₘ (RXSiO)ₙ]
with m+n=z and z≧4, z corresponding to the number of silicon atoms in the framework structure of the polyhedral oligomeric silicon-oxygen cluster unit, and R=a hydrogen atom or alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units, attached via a polymer unit or a bridge unit,
X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group or substituents of type R containing at least one such group of type X, the substituents of type R being identical or different and the substituents of type X being identical or different.

In a further embodiment of the crosslinker it is possible for at least two of the substituents of type R to be different, in which case the crosslinker is said to have a functionalized heteroleptic structure thus
[(RSiO_{1.5})ₘ (RXSiO)ₙ]
with m+n=z and z≧4, z corresponding to the number of silicon atoms in the framework structure of the polyhedral oligomeric silicon-oxygen cluster unit, and R=a hydrogen atom or alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units, attached via a polymer unit or a bridge unit,
X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group or substituents of type R containing at least one such group of type X, the substituents of type R being identical or different and the substituents of type X being identical or different.

Very particular preference is given to functionalized oligomeric silsesquioxanes of structure 5 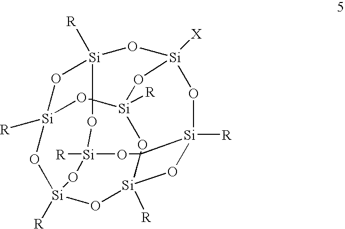
with R=a hydrogen atom or alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units, attached via a polymer unit or a bridge unit,
X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group or substituents of type R containing at least one such group of type X,

the substituents of type R being identical or different and the substituents of type X being identical or different.

Likewise particularly preferred are compounds whose polyhedral oligomeric silicon-oxygen cluster units are nonfunctionalized oligomeric silsesquioxane units.

Oligomeric spherosilicates have a construction similar to that of the oligomeric silsesquioxanes. They too possess a “cagelike” structure. Unlike the silsesquioxanes, owing to the method by which they are prepared, the silicon atoms at the comers of a spherosilicate are connected to a further oxygen atom, which in turn is further substituted. Oligomeric spherosilicates can be prepared by silylating suitable silicate precursors (D. Hoebbel, W. Wieker, Z. Anorg. Allg. Chem. 384 (1971), 43-52; P. A. Agaskar, Colloids Surf. 63 (1992), 131-8; P. G. Harrison, R. Kannengiesser, C. J. Hall, J. Main Group Met. Chem. 20 (1997), 137-141; R. Weidner, Zeller, B. Deubzer, V. Frey, Ger. Offen. (1990), DE 38 37 397). For example, the spherosilicate with structure 7 can be synthesized from the silicate precursor of structure 6, which in turn is obtainable by the reaction of Si(OEt)₄ with choline silicate or by the reaction of waste products from the harvesting of rice with tetramethylammonium hydroxide (R. M. Laine, I. Hasegawa, C. Brick, J. Kampf, Abstracts of Papers, 222nd ACS National Meeting, Chicago, Ill., United States, Aug. 26-30, 2001, MTLS-018).

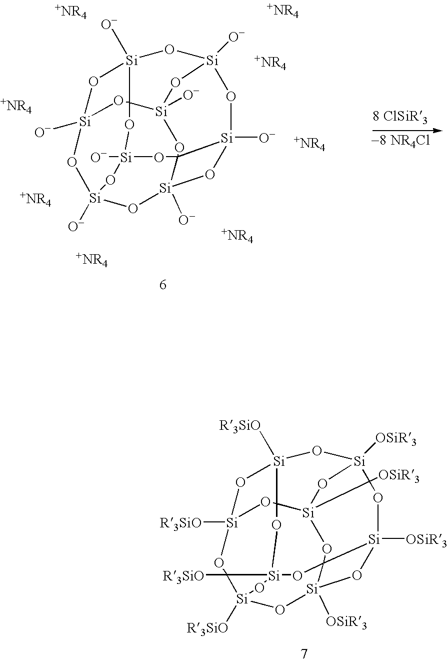

If the compound II comprising polyhedral oligomeric silicon-oxygen clusters is from the class of compounds of the spherosilicates, they possess the following formula:
[(RₑX_{f}Si₂O_{2.5})ₒ (R_{g}XₕSi₂O₂)ₚ]
with e, f, g=0-3; h=1-4; o+p≧4; e+f=3, and g+h=4.

Preferred compounds are those whose polyhedral oligomeric silicon-oxygen cluster units are functionalized oligomeric spherosilicate units.

Likewise preferred are compounds whose polyhedral oligomeric silicon-oxygen cluster units are nonfunctionalized oligomeric spherosilicate units.

Both the silsesquioxanes and the spherosilicates are thermally stable at temperatures of up to several hundred degrees Celsius.

The class of compounds of the silsesquioxanes is employed with particular preference.

Further information relating to the functionalized compounds II containing polyhedral oligomeric silicon-oxygen cluster units, concerning their synthesis, for example, is described in, for example, DE 102 20 853.0, DE 102 20 853.0, and DE 103 01 754.2.

Auxiliaries and additives III are the compounds commonly employed for powder coating materials. Examples include leveling agents, light stabilizers, and devolatilizers. They can be used at from 0 to 5% by weight. It is additionally possible to employ pigments and fillers, examples being metal oxides such as titanium dioxide, and metal hydroxides, sulfates, sulfides, carbonates, silicates, talc, carbon black, etc., in weight fractions of from 0 to 50%.

To prepare the ready-to-use powder coating composition the ingredients are mixed. The ingredients can be homogenized in suitable equipment, such as heatable kneading apparatus, for example, but preferably by extrusion, in the course of which upper temperature limits of 140° C., preferably of 130° C., more preferably of 120° C., ought not to be exceeded. After it has been cooled to room temperature and appropriately comminuted, the extruded mass is ground without adding coolants to form the ready-to-spray powder. Application of this powder to appropriate substrates can take place in accordance with the known techniques, such as, for example, by electrostatic or tribostatic powder spraying, or fluid-bed sintering, with or without electrostatic assistance. Examples of suitable substrates include untreated or pretreated metallic substrates, wood, wood materials, plastics, glass, and paper.

The coatings produced from the thermally curable powder coating compositions of the invention are flexible and hard, adhere well and possess a hydrophobic surface. The invention additionally provides the coatings of the type described.

### EXAMPLES

The invention is illustrated by the examples which follow.

### Example 1

### Instructions for Preparing the Amorphous Polyesterpolyol

69 kg of isophthalic acid, 43 kg of neopentyl glycol and 2 kg of trimethylolpropane were admixed with 0.2 percent by mass of n-butyltin trioctanoate and heated to 190° C. under nitrogen and with stirring in an apparatus provided with a distillation column. In the course of the removal of water, this temperature was slowly raised to 230° C. After about 98% of the theoretical amount of water had been distilled off, the hot reaction mixture was poured from the flask onto a sheet. As soon as the reaction mass had solidified and cooled, it was mechanically comminuted and ground. The hydroxyl number of this product was 29 mg KOH/g, the acid number 1.5 mg KOH/g, and the glass transition temperature 54° C.

### Example 2

### Preparation of the Amorphous Polyaddition Compound Having Uretdione Groups

74.0 g of chlorine-free IPDI uretdione and 0.05 g of DBTL were dissolved at 50° C. in 37 g of acetone. Thereafter 12.4 g of hexane-1,6-diol were added. After reaction had taken place, 13.6 g of 2-ethylhexanol in solution in 6 g of acetone were added dropwise. The reaction was over after about 1 hour. The solvent was removed on a rotary evaporator. The product had a free NCO content of <0.1%. The latent NCO content was 14.2%.

### Example 3

### Preparation of the Silsesquioxane (Isobutyl)₈Si₈O₁₂

Added with stirring to a solution of 446 g of isobutyltrimethoxysilane (isobutyl)Si(OMe)₃ in 4300 ml of acetone was a solution of 6.4 g of KOH in 200 ml of H₂O. The reaction mixture was subsequently stirred at 30° C. for 3 days. The precipitate formed was isolated by filtration and dried under reduced pressure at 70° C. The product, (isobutyl)₈Si₈O₁₂, was obtained in a yield of 262 g (96%).

### Example 4

### Preparation of the Inventive Powder Coating Compositions

804 g of the amorphous polyesterpolyol from Example 1 and 130 g of the amorphous polyaddition compound having uretdione groups from Example 2 were admixed with 10 g of BYK 361 (leveling agent, BYK Chemie), 5 g of benzoin (devolatilizer from Merck-Schuchardt) and 1 g of dibutyltin dilaurate (catalyst from Crompton Vinyl Additives GmbH) and with 50 g of the silsesquioxane (isobutyl)₈Si₈O₁₂ from Example 3. The comminuted ingredients were intimately mixed in an edge runner mill and the mixture was subsequently homogenized in an extruder at up to 130° C. maximum. After cooling, the extrudate was fractionated and ground using a pinned-disk mill to a particle size <100 μm. The powder produced in this way was applied to degreased standard steel panels using an electrostatic powder spraying unit at 60 kV. The coated panels were then baked at 180° C. for 30 minutes.

### Example 5

### Preparation of the Powder Coating Composition Without Silsesquioxane (Comparative)

The powder coating composition was prepared in analogy to the inventive powder coating composition from Example 4. However, the addition of the silsesquioxane (isobutyl)₈Si₈O₁₂ from Example 3 was omitted.

The test results are summarized in Table 1:

TABLE 1

| | | | | Ball impact | | |
|---|---|---|---|---|---|---|
| | | HK¹ | EC² | d./i.³ | | angle⁵ |
| Example | Substrate | [sec] | [mm] | [inch · lb] | CC⁴ | [°] |
| 4 | Standard | 189 | >10 | >80/>80 | 0 | 108 |
| | steel | | | | | |
| 5 | Standard | 230 | >10 | >80/40 | 0 | 94 |
| (comparative) | steel | | | | | |

¹König hardness (DIN 53 157)
²Erichsen cupping (DIN 53 156)
³Impact indentation, direct/indirect (ASTM D 2794-93)
⁴Cross-cut (DIN 53153, ISO 2409) (scale 0 (no loss of adhesion) to 5 (total loss of adhesion))
⁵Contact angle with a 60 μl water drop

The coating from Example 4 produced from the inventive powder coating composition has a more hydrophobic surface as a result of the addition of the silsesquioxane. Consequently the powder coating possesses a water repellency effect. The mechanical coating properties, such as hardness, flexibility, and adhesion, remain at the very high level even after addition of the silsesquioxane. The noninventive Comparative Example 5 exhibits weaknesses in the hydrophobicity of the coating.

The disclosure of the priority document, German Application No. DE 103 31 796.1, filed Jul. 11, 2003, is incorporated by reference herein in its entirety.

1. A thermally curable powder coating composition comprising
I. a binder comprising
a) at least one compound having on average more than one functional group and
b) at least one compound having on average more than one functional group complementary to a); and
II. at least one compound comprising at least one polyhedral oligomeric silicon-oxygen cluster unit, in accordance with the formula
[(RₐX_{b}SiO_{1.5})ₘ (R_{c}X_{d}SiO)ₙ (RₑX_{f}Si₂O_{2.5})ₒ (R_{g}XₕSi₂O₂)ₚ]
with
a, b, c=0-1; d=1-2; e, f, g=0-3; h=1-4; m+n+o+p≧4; a+b=1; c+d=2; e+f=3 and g+h=4;
R=a hydrogen atom, alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units, attached via a polymer unit or a bridge unit,
X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group or substituents of type R containing at least one such group of type X,
the substituents of type R being identical or different, and
the substituents of type X being identical or different, and
III. auxiliaries and additives.

2. The composition as claimed in claim 1, wherein the binder I a) is a low molecular mass oligomeric or polymeric compound.

3. The composition as claimed in claim 1, wherein the functional groups present in the binder I a) are identical to or different from one another.

4. The composition as claimed in claim 1, wherein the functional groups present in the binder I a) are C—C double bonds or OH—, SH—, COOH— or epoxy groups.

5. The composition as claimed in claim 1, wherein the binder I a) possesses a melting range between 50 and 140° C.

6. The composition as claimed in claim 1, wherein the binder I a) is amorphous.

7. The composition as claimed in claim 1, wherein the binder I a) is (semi)crystalline.

8. The composition as claimed in claim 1, wherein the binder I a) is hyperbranched.

9. The composition as claimed in claim 1, wherein the binder I a) is dendrimeric.

10. The composition as claimed in claim 1, wherein the binder I a) is selected from the group consisting of polyethers, polythioethers, polyacetals, polyesteramides, epoxy resins, amino resins, polyazomethines, polyurethanes, polysulfonamides, melamine derivatives, cellulose esters, cellulose ethers, polyvinyl esters, polyesters and acrylate resins.

11. The composition as claimed in claim 1, wherein the binder I a) comprises polyesters, polyacrylates or epoxy resins, each of which carries one or more hydroxyl group, carboxyl group or epoxy group.

12. The composition as claimed in claim 1, wherein the binder I b) is a low molecular mass oligomeric or polymeric compound.

13. The composition as claimed in claim 1, wherein the functional groups present in the binder I b) are identical to or different from one another.

14. The composition as claimed in claim 1, wherein the binder I b) possesses a melting range between 50 and 140° C.

15. The composition as claimed in claim 1, wherein the binder I b) is amorphous.

16. The composition as claimed in claim 1, wherein the binder I b) is (semi)crystalline.

17. The composition as claimed in claim 1, wherein the binder I b) is selected from the group consisting of epoxides, β-hydroxyalkylamides, carboxylic acids, carboxylic anhydrides, isocyanates, uretdiones, glycolurils and tris(alkoxycarbonylamino)-1,3,5-triazines.

18. The composition as claimed in claim 1, wherein the binder I b) is selected from the group consisting of triglycidyl isocyanurate, aromatic glycidyl esters, epoxidized fatty acid esters, dicarboxylic acids, polycarboxylic acids, carboxylic anhydrides, blocked isocyanate adducts, polyaddition compounds having uretdione groups, methoxymethylglycoluril, 2,4,6-tris(methoxycarbonylamino)-1,3,5-triazine, 2,4,6-tris(butoxycarbonylamino)-1 ,3,5-triazine, 2,4,6-tris(ethylhexoxy-carbonylamino)-1,3,5 -triazine, 2-phenylimidazoline, and salts of pyromellitic acid with 2-phenylimidazoline.

19. The composition as claimed in claim 1, wherein the binder I comprises a combination selected from the group consisting of
a polyester having carboxyl end groups with triglycidyl isocyanurate,
a polyester having carboxyl end groups with a mixture of aromatic glycidyl esters,
a polyester having carboxyl end groups with a β-hydroxyalkylamide,
a polyester having carboxyl end groups with an aliphatic oxirane,
a glycidyl methacrylate resin with dodecanedioic acid,
a polyesterpolyol with a blocked isocyanate adduct,
a polyesterpolyol with a polyaddition compound having uretdione groups,
a polyesterpolyol with methoxymethylglycoluril,
a polyesterpolyol with 2,4,6-tris(methoxycarbonylamino)-1,3,5-triazine or 2,4,6-tris(butoxycarbonylamino)-1,3,5-triazine,
an epoxy resin with 2,4,6-tris(methoxycarbonylamino)-1,3,5-triazine or 2,4,6-tris(butoxycarbonylamino)-1,3,5-triazine,
an epoxy resin with 2-phenylimidazoline,
an epoxy resin with a polyester having carboxyl end groups or an epoxy resin, and
a polyester having carboxyl end groups with an organic salt.

20. The composition as claimed in claim 1, wherein
the polyhedral oligomeric silicon-oxygen cluster unit is functionalized; and
X contains a functional group.

21. The composition as claimed in claim 1, wherein at least one of the substituents of type X of the polyhedral oligomeric silicon-oxygen cluster unit contains an amino group.

22. The composition as claimed in claim 1, wherein at least one of the substituents of type X of the polyhedral oligomeric silicon-oxygen cluster unit contains an isocyanate or blocked isocyanate group.

23. The composition as claimed in claim 1, wherein at least one of the substituents of type X of the polyhedral oligomeric silicon-oxygen cluster unit contains an acrylate or methacrylate group.

24. The composition as claimed in claim 1, wherein at least one of the substituents of type X of the polyhedral oligomeric silicon-oxygen cluster unit contains an alkoxysilyl or alkoxysilylalkyl group.

25. The composition as claimed in claim 1, wherein at least one of the substituents of type X of the polyhedral oligomeric silicon-oxygen cluster unit contains an epoxy group.

26. The composition as claimed in claim 1, wherein at least one of the substituents of type X of the polyhedral oligomeric silicon-oxygen cluster unit contains a hydroxyl group.

27. The composition as claimed in claim 1, wherein at least two of the substituents of type X of the polyhedral oligomeric silicon-oxygen cluster unit are different.

28. The composition as claimed in claim 1, wherein at least two of the substituents of type X of the polyhedral oligomeric silicon-oxygen cluster unit are identical.

29. The composition as claimed in claim 1, wherein the polyhedral oligomeric silicon-oxygen cluster unit is based essentially on structure 1 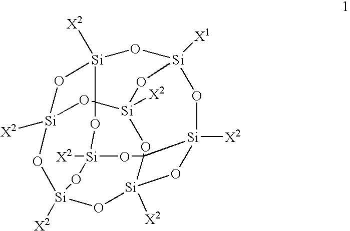
with
X¹=substituent of type X or of type —O—SiX₃, and
X²=substituent of type X, of type —O—SiX₃, of type R, of type —O—SiX₂R, of type —O—SiXR₂ or of type —O—SiR₃.

30. The composition as claimed in claim 1, wherein the polyhedral oligomeric silicon-oxygen cluster unit is a functionalized oligomeric silsesquioxane unit.

31. The composition as claimed in claim 30, wherein the silsesquioxane unit has a functionalized homoleptic structure, all substituents of type R being identical.

32. The composition as claimed in claim 30, wherein the silsesquioxane unit has a functionalized heteroleptic structure, at least two of the substituents of type R being different.

33. The composition as claimed in claim 30, wherein the functionalized oligomeric silsesquioxane unit is obtained by reacting silsesquioxane units having free hydroxyl groups with monomeric functionalized silanes of the structure Y₃Si—X¹, Y₂SiX¹X² and YSiX¹X²X³, the substituent Y being a leaving group selected from alkoxy, carboxyl, halo, silyloxy, and amino groups, and the substituents X¹, X², and X³ being of type X and being identical or different.

34. The composition as claimed in claim 30, wherein the functionalized oligomeric silsesquioxane unit is based essentially on structure 2, 3 or 4, 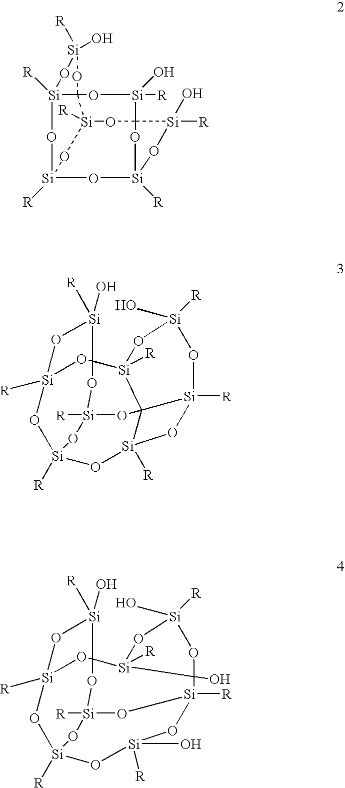
where the silsesquioxane unit is functionalized by way of at least one hydroxyl group.

35. The composition as claimed in claim 30, wherein the functionalized oligomeric silsesquioxane unit is based essentially on structure 5 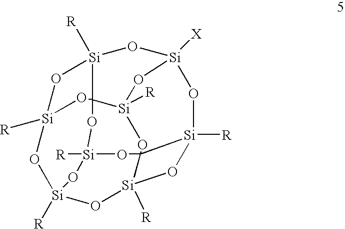
with R=a hydrogen atom or alkyl, cycloalkyl, alkenyl, cycloalkenyl, alkynyl, cycloalkynyl, aryl or heteroaryl group or polymer unit, each of which is substituted or unsubstituted, or further functionalized polyhedral oligomeric silicon-oxygen cluster units, attached via a polymer unit or a bridge unit,
X=an oxy, hydroxyl, alkoxy, carboxyl, silyl, alkylsilyl, alkoxysilyl, siloxy, alkylsiloxy, alkoxysiloxy, silylalkyl, alkoxysilylalkyl, alkylsilylalkyl, halo, epoxy, ester, fluoroalkyl, isocyanate, blocked isocyanate, acrylate, methacrylate, nitrile, amino or phosphine group or substituents of type R containing at least one such group of type X,
the substituents of type R being identical or different, and
the substituents of type X being identical or different.

36. The composition as claimed in claim 1, wherein the polyhedral oligomeric silicon-oxygen cluster unit is a nonfunctionalized oligomeric silsesquioxane unit.

37. The composition as claimed in claim 1, wherein the polyhedral oligomeric silicon-oxygen cluster unit is a functionalized oligomeric spherosilicate unit.

38. The composition as claimed in claim 1, wherein the polyhedral oligomeric silicon-oxygen cluster unit is a nonfunctionalized oligomeric spherosilicate unit.

39. The composition as claimed in claim 1, wherein the auxiliaries and additives III are selected from the group consisting of UV initiators, leveling agents, light stabilizers, devolatilizers, pigments and fillers.

40. A method of making a thermally curable powder coating composition, the method comprising
mixing ingredients at a temperature no higher than 140° C.; and
producing the composition of claim 1.

41. A method of using a thermally curable powder coating composition to produce a coating, the method comprising
applying the composition of claim 1 on a substrate; and
producing the coating.

42. A coating produced by the method of claim 41.
